(19) United States
(12) Patent Application Publication
(10) Pub. No.: US 2014/0214844 A1
(43) Pub. Date: Jul. 31, 2014

(54) MULTIPLE CLASSIFICATION MODELS IN A PIPELINE

(71) Applicant: WAL-MART STORES, INC., Bentonville, AR (US)

(72) Inventors: Nikesh Lucky Garera, Mountain View, CA (US); Narasimhan Rampalli, Los Altos, CA (US); Dintyala Venkata Subrahmanya Ravikant, San Bruno, CA (US); Srikanth Subramaniam, San Jose, CA (US); Chong Sun, Redwood City, CA (US); Heather Dawn Yalln, Alameda, CA (US)

(73) Assignee: Wal-Mart Stores, Inc., Bentonville, AR (US)

(21) Appl. No.: 13/756,450

(22) Filed: Jan. 31, 2013

(51) Int. Cl. G06F 17/30

(52) U.S. Cl. CPC G06F 17/30598
USPC 707/740

(57) ABSTRACT

The present disclosure extends to methods, systems, and computer program products for updating a merchant database with new items automatically or with minimal human involvement. In operation, methods and systems disclosed use a pipeline of classification models to quantify new product information and create an accurate classification for the new product item.

### BACKGROUND

Retailers often have databases and warehouses full of thousands upon thousands of products offered for sale, with new products being offered every day. The databases must be updated with these new products in an organized and usable manner. Each product and new product should be categorized within the database so that it can be found by customers for purchase or employees for stocking. The large number of products offered for sale by a merchant makes updating a merchant's product database difficult and costly with current methods and systems.

These problems apply even with the use of computers and current computing systems. The disclosed methods and systems herein, provide more efficient and cost effective methods and systems for merchants to keep product databases up to date with new product offerings.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example computer architecture that facilitates different implementations described herein;

FIG. 3 illustrates a flow chart of an example method according to one implementation;

FIG. 4 illustrates a flow chart of an example method according to one implementation; and

FIG. 5 illustrates a flow chart of an example method according to one implementation.

### DETAILED DESCRIPTION

The present disclosure extends to methods, systems, and computer program products for providing merchant database updates for new product items. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

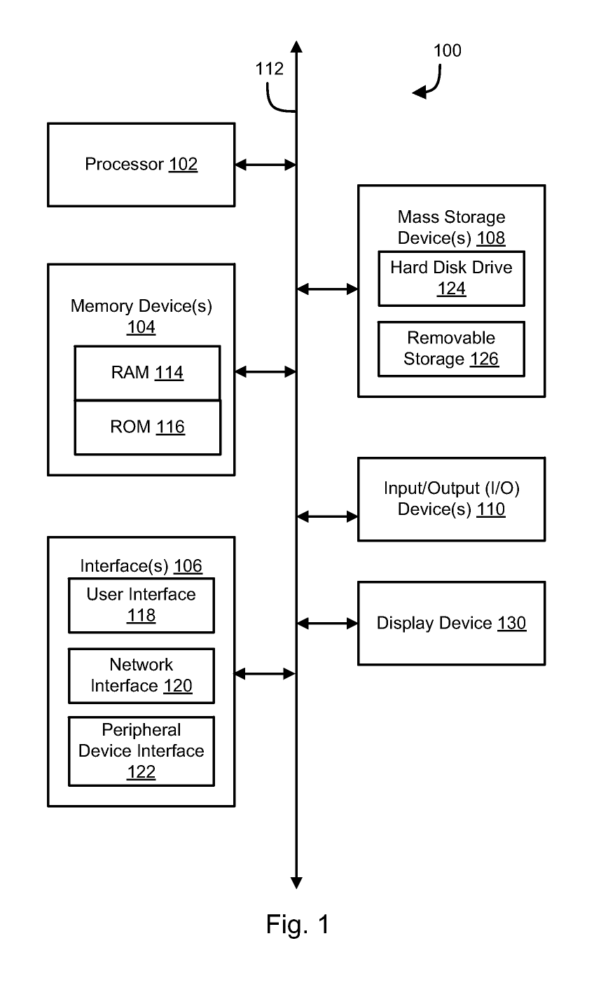

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

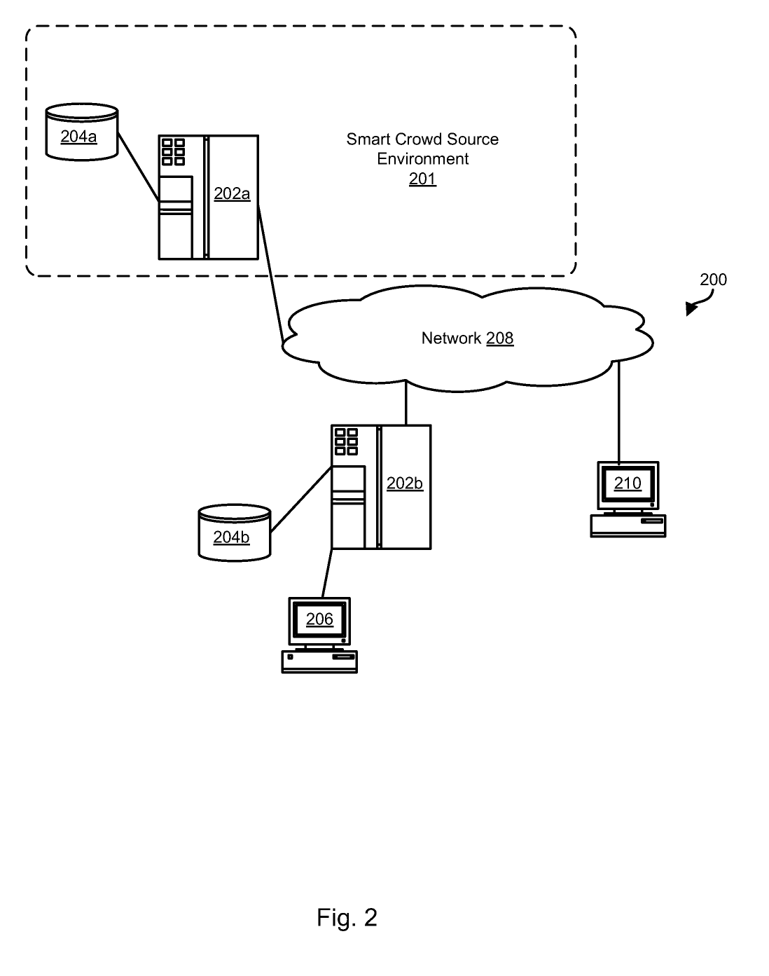

FIG. 2 illustrates an example of a computing environment 200 and a smart crowd source environment 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

As used herein, a smart crowd source environment is a group of users connected over a network that are assigned tasks to perform over the network. In an implementation the smart crowd source may be in the employ of a merchant, or may be under contract with on a per task basis. The work product of the smart crowd source is generally conveyed over the same network that supplied the tasks to be performed. In the implementations that follow, users or members of a smart crowd source may be tasked with reviewing the classification of new product items and the hierarchy of products within a merchant's database.

A server 202b may be associated with a classification manager or other entity or party providing classification work. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

As used herein, a classification model pipeline is intended to mean plurality of classification models organized to optimize the classification of new product items that are to be added to a merchant database. The plurality of classification models may be run in a predetermined order or may be run concurrently. The classification model pipeline may require that new product items be processed by all of the classification models within the pipeline, or may allow the classification process to stop before all of the classification models are run if predetermined thresholds are not met.

It is to be further understood that the phrase “computer system,” as used herein, shall be construed broadly to include a network as defined herein, as well as a single-unit work station (such as work station 206 or other work station) whether connected directly to a network via a communications connection or disconnected from a network, as well as a group of single-unit work stations which can share data or information through non-network means such as a flash drive or any suitable non-network means for sharing data now known or later discovered.

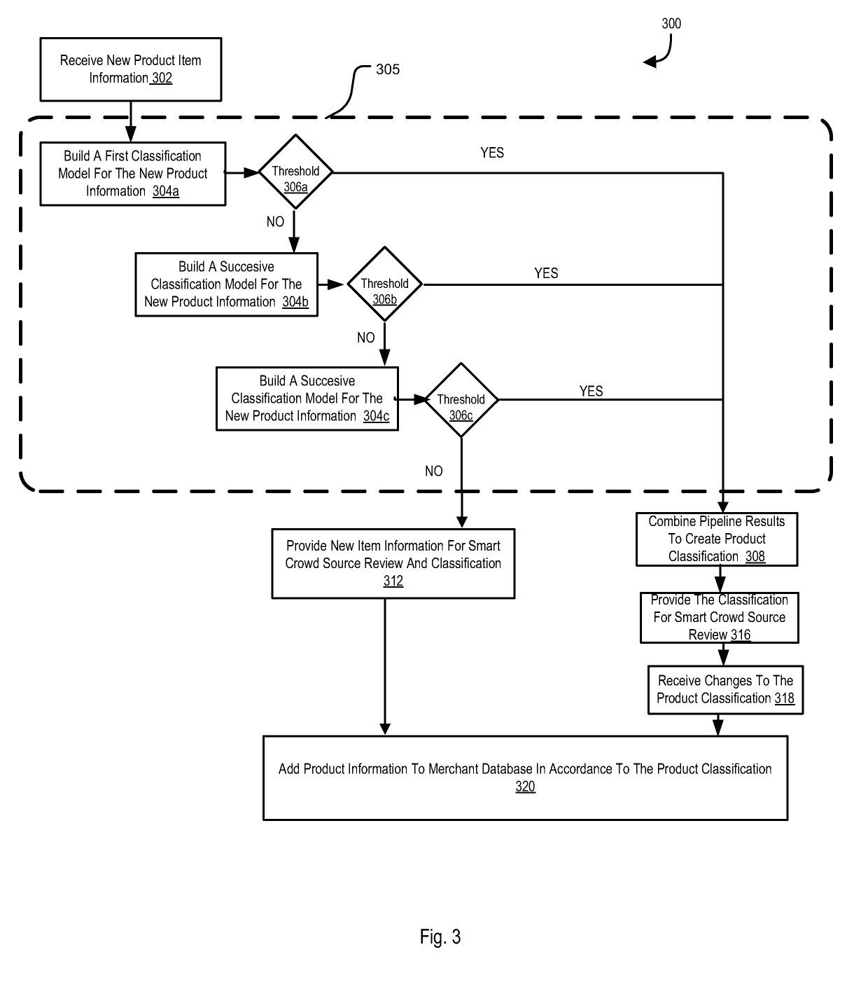

With reference primarily to FIG. 3, an implementation of a method 300 for updating a merchant's database through semantic product classification will be discussed. FIG. 1 and FIG. 2 may be referenced secondarily during the discussion in order to provide hardware support for the implementation. The disclosure aims to disclose methods and systems to allow a new product item to be automatically and efficiently added to a product database. For example, a product item may have a description and title associated with it that contains terms and values that can be quantified by at least one classification model such that the new product item can be categorized within a merchant's database. In an implementation the title and description may be combined to supply quantifiable information that may be used to analyze and classify a product item so that it can properly be categorized within a database automatically, or alternatively with limited human involvement.

The method 300 may be performed on a system that may include the database storage 204a (or any suitable memory device disposed in communication with the network 208) receiving a new product item information 302 representing the new product item to be sold by a merchant. The product item information may be stored in memory located within computing environment 200 for later classification by the classification models within a pipeline. The product item information may be received into the computing environment in digital form from an electronic database in communication with the merchant's system. Additionally, the new product item information may be manually input by a user connected electronically with the computing environment 200. The new product item information may comprise a title, a description, parameters of use and performance, and any other suitable information associated with the product that may be of interest in a merchant environment for identifying, quantifying and categorizing the new product item.

At 304a, the system may build a first classification model within the classification model pipeline 305 for the new product item based on the product item information received at 302. The classification model pipeline is shown as the dashed boundary line labeled 305, and illustrates the plurality of classification models (at 304a, 304b, 303c) that makeup the classification model pipeline for the illustrated implementation. A classification model may be used within the computing environment 200 to quantify properties of the new product item by performing an algorithm or series of algorithms against the text properties (titles, description terms, images) provided in the new product item information received at 302 in order to quantify and ultimately classify the new product item relative to existing products items already in a merchant's database. Examples of classification models are: Naïve Bayes, K-Nearest-Neighbors, SVM, logistic regression, and multiclass perceptron, or the like. It should be understood that any classification model that is known or yet to be discovered is to be considered within the scope of this disclosure. It is to be contemplated that the first classification model may comprise a single algorithm or a plurality of algorithms as desired to classify the new product item. At 303b, the results of the classification model may be stored in memory within computing environment 200.

A classification model pipeline 305 is intended to comprise a plurality of classification models organized to optimize the classification of new product items that are to be added to a merchant database. The plurality of classification models may be run in a predetermined order, as illustrated in the figure, such that the result of the first classification model 304a is processed by the successive classification models 304b, 304c to produce more accurate and refined classification results as the new product information is processed through each classification model in the classification model pipeline 305. The classification model pipeline 305 may require that new product items be processed by all of the classification models within the pipeline, or may allow the classification process to stop before all of the classification models are run if predetermined thresholds are met.

At 306a, 306b and 306c, the classification model results of classification models 304a, 304b and 304c are checked against a predetermined threshold. In an implementation a threshold may be a minimum accuracy requirement, key word requirement, or field values requirement for fields needed within a merchant's database.

It should be noted, that a single threshold may be set for the entire classification model pipeline 305 such that the results of each classification model is checked against the same threshold. Alternatively, in an implementation each classification model may have a corresponding threshold that corresponds to the capability of the classification model being used at each step in the pipeline. For discussion purposes, the threshold for the implementation illustrated in FIG. 3 is the same throughout the pipeline 305 such that the thresholds at 306a, 306b, 306c are equivalent. For example, at 306a the results of the classification model of 304a are compared against a predetermined pipeline threshold. If the threshold is met at 306a a classification for the new product item can be created at 308 from the results of the classification model built at 304a. Alternatively, if the threshold is not met at 306a the results of the first classification model can be processed and refined by a successive classification model built at 304b.

Continuing on, at 306b the results of the classification model of 304b are compared against a predetermined pipeline threshold. If the threshold is met at 306b a classification for the new product item may be created at 308 from the results of the classification model built at 304b. Alternatively, if the threshold is not met at 306b the results of the successive classification model built at 304b can be processed and refined by yet another successive classification model built at 304c.

For completeness in discussing FIG. 3, at 306c the results of the classification model of 304c are compared against a predetermined pipeline threshold. If the threshold is met at 306c a classification for the new product item can be created at 308 from the results of the classification model built at 304c. Alternatively, if the threshold is not met at 306c the results of the successive classification model built at 304c can be processed and refined by yet another successive classification model, or may be presented for smart crowd source review at 312 because it is deemed too difficult for machine (classification model) classification.

It should be noted that in a classification model pipeline implementation, the first and successive classification models may be different, while in another implementation the first and successive classification models may be the same.

At 308, the results of the first classification model and successive classification models may be combined to create a refined product classification for the new product item. In an implementation the results of successive classification models may be used complementary to the results of other classification models in an additive manner in order to emphasize or deemphasize certain aspects of the product information. Alternatively, the results of the first and successive classification models may be used in subtractive manner to emphasize or deemphasize certain aspects of the product information for the new product item classification.

At 312, the new product item classification may be presented to a plurality of users for smart crowd source review. The smart crowd source review may be used to check the new product classification created at 308 for accuracy and relevancy. For example, a new product item may be car tires for a scale model of a popular automobile that a merchant also provides tires for. If by chance that the classification models missed text values in the new product item information that denoted the tires were for a scale model, the scale model tires may appear in the merchants data base as full size tires for an actual automobile. A smart crowd user could readily spot such an anomaly and provide corrective information.

At 316, any classification created entirely by the classification models with in the pipeline 305 may be present to a plurality of users for smart crowd source review as discussed previously.

At 318, the smart crowd corrections are received by the system and may be added to the product classification and stored within the memory of the computing environment 200. It should be noted that the smart crowd users may be connected over a network, or may be located within a brick and mortar building owned by the merchant. The smart crowd users maybe employees and representatives of the merchant, or may be outsourced to smart crowd communities.

At 320, the new product item may be added to the merchant database and properly classified relative to existing products within the merchant database. As can be realized from the discussion above, a merchant can efficiently and cost effectively add new product items to their inventory by practicing the method 300 which takes advantage of a pipeline of classification models to accurately classify the product item.

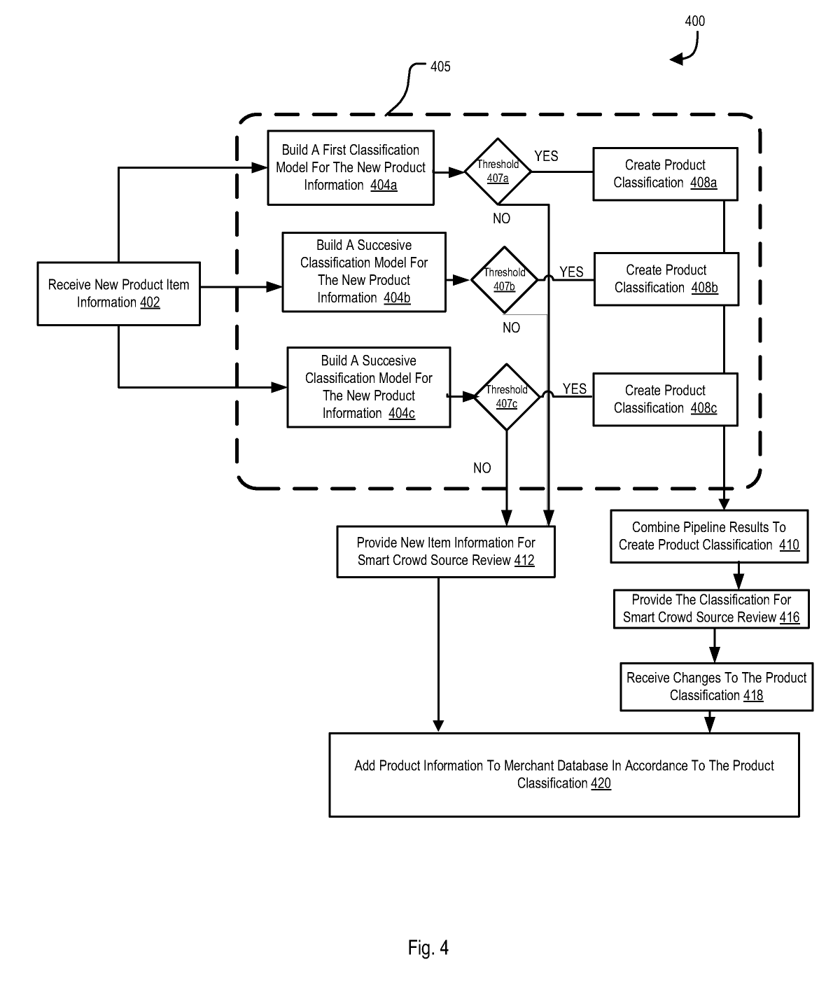

With reference primarily to FIG. 4, an implementation of a method 400 for updating a merchant's database through semantic product classification will be discussed. FIG. 1 and FIG. 2 may be referenced secondarily during the discussion in order to provide hardware support for the implementation. The disclosure aims to disclose methods and systems to allow a product to be automatically and efficiently added to a product database. For example, a product item may have a description and title associated with it that contains terms and values that can be quantified by at least one classification model such that the new product item can be categorized within a merchant's database. In an implementation the title and description may be combined to supply quantifiable information that may be used to analyze and classify a product item so that it can properly be categorized within a database automatically or with limited human involvement.

The method 400 may be performed on a system that may include the database storage 204a (or any suitable memory device disposed in communication with the network 208) receiving a new product item information 402 representing the new product item to be sold by a merchant. The product item information may be stored in memory located within computing environment 200 for later classification by the classification models within a pipeline. The product item information may be received into the computing environment in digital form from an electronic database in communication with the merchant's system, or may be manually input by a user connected electronically within the computing environment. The new product item information may comprise a title, a description, parameters of use and performance, and any other suitable information associated with the product that may be of interest in a merchant environment for identifying, quantifying and categorizing the new product item.

At 404a, 404b, 404c the system may build a plurality of classification models within the classification model pipeline 405 for the new product item based on the product item information received at 402. The classification model pipeline is shown as the dashed boundary line labeled 405, and illustrates the plurality of classification models that makeup the classification model pipeline for the illustrated implementation. A classification model may be used within the computing environment 200 to quantify properties of the new product item by performing an algorithm or series of algorithm against the properties (titles, description terms, images) provided in the new product item information received at 402 in order to quantify and ultimately classify the new product item relative to existing products already in a merchant's database. Examples of classification models are: Naïve Bayes, K-Nearest-Neighbors, SVM, logistic regression, and multiclass perceptron, and like models. It should be understood that any classification model that is known or yet to be discovered is to be considered within the scope of this disclosure. It is to be contemplated that the first classification model may comprise a single algorithm or a plurality of algorithms as desired to classify the new product item.

A classification model pipeline 405 is intended to mean plurality of classification models organized to optimize the classification of new product items that are to be added to a merchant database. The plurality of classification models may be run in a predetermined order as illustrated in the figure such that the new product item information is processed by the first classification model 404a and successive classification models 404b, 404c to produce a plurality of classifications that can be combined to form an accurate classification results as the new product information is processed by each classification model pipeline 405.

At 406a, 406b and 406c, the classification model results of classification models 404a, 404b and 404c are checked against a predetermined threshold. In an implementation a threshold may be a minimum accuracy requirement, key word requirement, or field values requirement for fields needed within a merchant's database.

It should be noted, that a single threshold may be set for the entire classification model pipeline 405 in an implementation such that results of each classification model is checked against the same threshold. In an implementation each classification model may have a corresponding threshold that corresponds to the capability of the classification model being used. For discussion purposes, the thresholds for the implementation illustrated in FIG. 4 are different for each of the classification models throughout the pipeline 405. For example, at 406a the results of the classification model of 404a are compared against a predetermined threshold that specifically corresponds to the classification model built 404a. If the threshold is met at 406a a classification for the new product item can be created at 408a from the results of the classification model built at 404a. Alternatively, if the threshold is not met at 406a the results of the first classification model can be presented to a smart crowd source review at 416.

Continuing on, at 406b the results of the classification model of 404b are compared against a predetermined threshold that specifically corresponds to the classification model built 404b. If the threshold is met at 406b a classification for the new product item can be created at 408b from the results of the classification model built at 404b. Alternatively, if the threshold is not met at 406b the results of the first classification model can be presented to a smart crowd source review at 416.

For completeness in discussing FIG. 4, at 406c the results of the classification model of 404c are compared against a predetermined threshold that specifically corresponds to the classification model built 404c. If the threshold is met at 406c, a classification for the new product item can be created at 408c from the results of the classification model built at 404c. Alternatively, if the threshold is not met at 406c the results of the first classification model can be presented to a smart crowd source review at 416.

At 410, the results of the first classification model and successive classification models may be combined to create a refined product classification for the new product item. In an implementation the results of successive classification models may be used complementary to the results of other classification models in an additive manner in order to emphasize or deemphasize certain aspects of the product information. Alternatively, the results of the first and successive classification models may be used in subtractive manner to emphasize or deemphasize certain aspects of the product information for the new product item classification.

At 412, the new product item classification may be presented to a plurality of users for smart crowd source review. The smart crowd source review may be used to check the new product classification created at 410 for accuracy and relevancy.

At 416, any classification created entirely by the classification models with in the pipeline 405 may be present to a plurality of users for smart crowd source review as discussed previously.

At 418, the smart crowd corrections are received by the system and may be added to the product classification and stored within memory of the computing environment 200. It should be noted that the smart crowd users may be connected over a network, or may be located within a brick and mortar building owned by the merchant. The smart crowd users maybe employees and/or representatives of the merchant, or may be outsourced to smart crowd communities.

At 420, the new product item may be added to the merchant database and properly classified relative to existing products within the merchant database. As can be realized from the discussion above, a merchant can efficiently and cost effectively add new product items to their inventory by practicing the method 400 which takes advantage of a pipeline of classification models to accurately classify the product item.

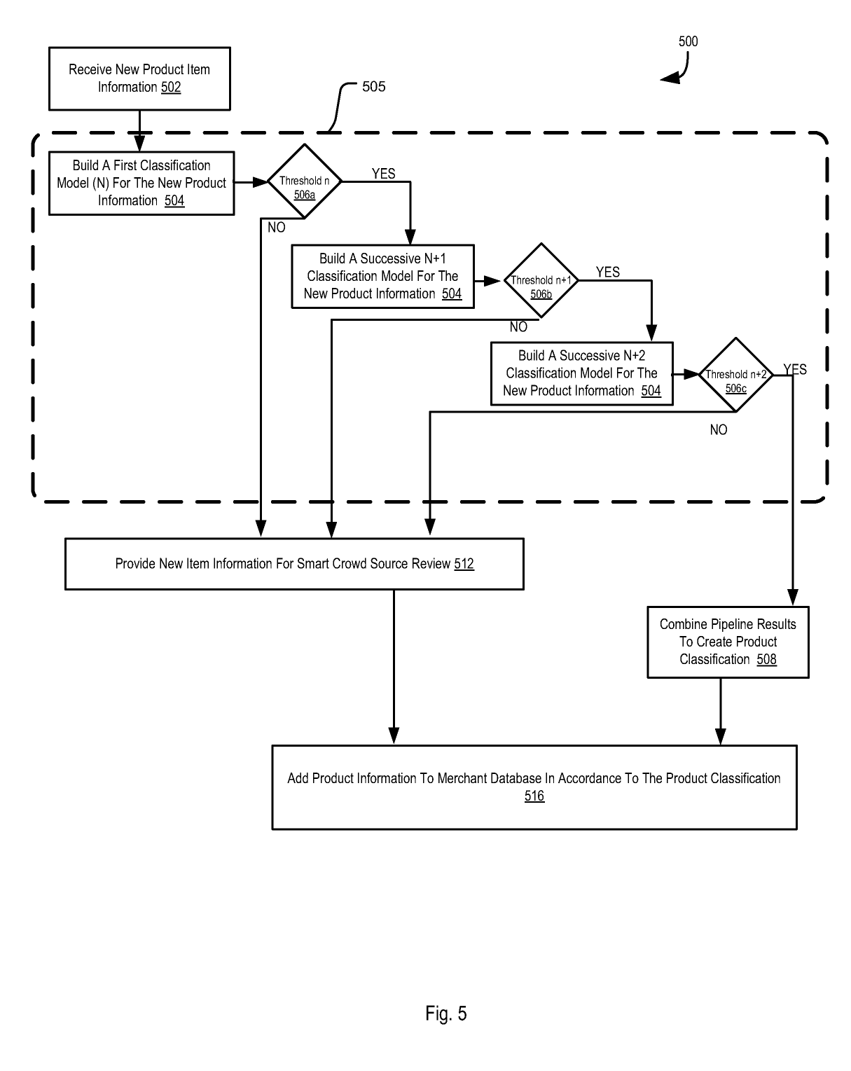

With reference primarily to FIG. 5, an implementation of a method 500 for updating a merchant's database through semantic product classification will be discussed. FIG. 1 and FIG. 2 may be referenced secondarily during the discussion in order to provide hardware support for the implementation. The disclosure aims to disclose methods and systems to allow a product to be automatically and efficiently added to a product database by quantifying information corresponding to the new item with a plurality of classification models in a classification model pipeline. For example, a product item may have a description and title associated with it that contains terms and values that can be quantified by at least one classification model such that the new product item can be categorized within a merchant's database. In an implementation the title and description may be combined to supply quantifiable information that may be used to analyze and classify a product item so that it can properly be categorized within a database automatically or with limited human involvement.

The method 500 may be performed on a system that may include the database storage 204a (or any suitable memory device disposed in communication with the network 208) receiving a new product item information 502 representing the new product item to be sold by a merchant. The product item information may be stored in memory located within computing environment 200 for later classification by the classification models within a pipeline. The product item information may be received into the computing environment in digital form from an electronic database in communication with the merchant's system, or may be manually input by a user connected electronically within the computing environment. The new product item information may comprise a title, a description, parameters of use and performance, and any other suitable information associated with the product that may be of interest in a merchant environment for identifying, quantifying and categorizing the new product item.

At 504a, the system may build a first classification model within the classification model pipeline 505 for the new product item based on the product item information received at 502. The classification model pipeline is shown as the dashed boundary line labeled 505, and illustrates the coordination of a plurality of classification models (504a, 504b, 503c) that makeup the classification model pipeline for the illustrated implementation. A classification model may be used within the computing environment 200 to quantify properties of the new product item by performing an algorithm or series of algorithm against the properties (titles, description terms, images) provided in the new product item information received at 502 in order to quantify and ultimately classify the new product item relative to existing products items already in a merchant's database. Examples of classification models are: Naïve Bayes, K-Nearest-Neighbors, SVM, logistic regression, and multiclass perceptron, or other like classification models. It should be understood that any classification model that is known or yet to be discovered is to be considered within the scope of this disclosure. It is to be contemplated that the first classification model may comprise a single algorithm or a plurality of algorithms as desired to classify the new product item. At 503b, the classification model may be stored in memory within computing environment 200.

A classification model pipeline 505 is intended to comprise plurality of classification models organized to optimize the classification of new product items that are to be added to a merchant database. The plurality of classification models may be run in a predetermined order as illustrated in the figure such that the result of the first classification model 504a is processed by the successive classification models 504b, 504c to produce more accurate and refined classification results as the new product information is processed through the entire classification model pipeline 305. The classification model pipeline 505 may require that new product items be processed by all of the classification models within the pipeline, or may allow the classification process to stop the classification models in the pipeline and rely upon a smart crowd source to create the classification if predetermined thresholds are met.

At 506a, 506b and 506c, the classification model results of classification models 504a, 504b and 504c are checked against a predetermined threshold. In an implementation a threshold may be a minimum accuracy requirement, key word requirement, or field values requirement for fields needed within a merchant's database.

In an implementation each classification model may have a corresponding threshold that corresponds to the capability of the classification model being used. For discussion purposes, the threshold for the implementation illustrated in FIG. 5 is for each classification model built within the pipeline 505. Additionally, it should be noted that there is not a limit to the number of classification models that may be included in a classification pipeline. For example, at 506a the results of the classification model(N) of 504a are compared against a corresponding threshold(n). In the present implementation N is used to denote the number of successive classification models within the pipeline, and n is used to denote the corresponding threshold to be used. If the threshold(n) is met at 506a a classification for the new product item can be created at 508 from the results of the classification model(N) built at 504a. Alternatively, if the threshold(n) is not met at 506a the results of the first classification model(N) can be processed and refined by a successive classification model(N+1) built at 504b.

Continuing on, at 506b the results of the classification model(N+1) of 504b are compared against a corresponding threshold(n+1). If the threshold(n+1) is met at 506b a classification for the new product item can be created at 508 from the results of the classification model(N+1) built at 504b. Alternatively, if the threshold(n+1) is not met at 506b the results of the successive classification model(n+1) built at 504b can be processed and refined by yet another successive classification model(N+2) built at 504c.

For completeness in discussing FIG. 5, at 506c the results of the classification model(N+2) of 504c are compared against a predetermined corresponding threshold(n+2). If the threshold(n+2) is met at 506c a classification for the new product item can be created at 508 from the results of the classification model(N+2) built at 504c. Alternatively, if the threshold(n+2) is not met at 506c the results of the successive classification model(N+2) built at 504c can be processed and refined by yet another successive classification model(N+J) where J represents any number of iterations. Alternatively, the classification results may be presented for smart crowd source review and classification at 512 because it is deemed too difficult for machine classification. In a classification model pipeline implementation the first and successive classification models may be different, while in another implementation the first and successive classification models may be the same.

At 508, the results of the first classification model and successive classification models may be combined to create a refined product classification for the new product item. In an implementation the results of successive classification models may be used complementary to the results of other classification models in an additive manner in order to emphasize or deemphasize certain aspects of the product information. Alternatively, the results of the first and successive classification models may be used in subtractive manner to emphasize or deemphasize certain aspects of the product information for the new product item classification.

At 512, the new product item classification may be presented to a plurality of users for smart crowd source review. The smart crowd source review may be used to check the new product classification created by the classification models for accuracy and relevancy.

At 516, the new product item may be added to the merchant database and properly classified relative to existing products within the merchant database. As can be realized from the discussion above, a merchant can efficiently and cost effectively add new product items to their inventory by practicing the method 500 which takes advantage of a pipeline of classification models to accurately classify the product item.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for categorizing a new product that is being added to a merchant's database of product offerings, comprising:
receiving, with a processor, new product information;
building, with a processor, a classification pipeline comprising:
a first classification model for the new product information for establishing a category for the new product;
a successive classification model for the new product information for establishing a category for the new product;
creating, with a processor, a new product classification by combining the first classification model results and successive classification model results;
comparing, with a processor, the new product classification against a predetermined threshold;
providing, with a processor, the new product classification to a plurality of users for review;
receiving, via a computer system, changes from the plurality of users;
modifying, with a processor, the new product classification to include the received changes from the plurality of users; and
adding the new product classification to the merchant's database.

2. A method according to claim 1, wherein said successive classification model is different from said first classification model.

3. A method according to claim 1, wherein each classification model corresponds to a predetermined threshold.

4. A method according to claim 1, further comprising: bypassing successive classification models if a preceding classification model result fails to meet a corresponding threshold.

5. A method according to claim 1, wherein a classification model is based on K-Nearest Neighbors.

6. A method according to claim 1, wherein a classification model is based on Naïve Bayes.

7. A method according to claim 1, wherein a classification model is based on logistic regression.

8. A method according to claim 1, wherein a classification model is based on multiclass perceptron.

9. A method according to claim 1, wherein successive classification models are different from preceding classification models.

10. A method according to claim 1, wherein a classification model is based on support vector machines.

11. A system for categorizing a new product that is being added to a merchant's database of product offerings comprising: one or more processors and one or more memory devices operably coupled to the one or more processors and storing executable and operational data, the executable and operational data effective to cause the one or more processors to:
receive new product information;
build a classification pipeline comprising:
a first classification model for the new product information for establishing a category for the new product;
a successive classification model for the new product information for establishing a category for the new product;
create a new product classification by combining first classification model results and successive classification model results;
compare the new product classification against a predetermined threshold;
provide the new product classification to a plurality of users for review;
receive changes from the plurality of users;
modify the new product classification to include the received changes from the plurality of users; and
add the new product classification to the merchant's database.

12. A system according to claim 11, wherein said second classification model is different from said first classification model.

13. A system according to claim 11, wherein the first or second classification model is based on K-Nearest Neighbors.

14. A system according to claim 11, wherein the first or second classification model is based on Naïve Bayes.

15. A system according to claim 11, wherein the first or second classification model is based on logistic regression.

16. A system according to claim 11, wherein the first or second classification model is based on support vector machines.

17. A system according to claim 11, wherein the first or second classification model is based on multiclass perceptron.

18. A system according to claim 11, wherein a classification model is based on support vector machines.

19. A system according to claim 11, wherein successive classification models are different from preceding classification models.

20. A system according to claim 11, wherein successive classification models are different from preceding classification models.
